(19) United States
(12) Patent Application Publication
(10) Pub. No.: US 2025/0149681 A1
(43) Pub. Date: May 8, 2025

(54) HOLLOW CYLINDRICAL BATTERY CELLS AND SYSTEM FOR CONTROLLING THE TEMPERATURE OF THE SAME

(71) Applicant: GM GLOBAL TECHNOLOGY OPERATIONS LLC, DETROIT, MI (US)

(72) Inventors: Tejas R. Bhavsar, Troy, MI (US); Mahesh A. Mummigatti, Bangalore (IN)

(21) Appl. No.: 18/504,421

(22) Filed: Nov. 8, 2023

(51) Int. Cl. H01M 10/6568; H01M 10/613; H01M 10/625; H01M 10/643; H01M 10/653; H01M 10/654; H01M 50/152; H01M 50/213

(52) U.S. Cl. CPC H01M 10/6568; H01M 10/613; H01M 10/625; H01M 10/643; H01M 10/653; H01M 10/654; H01M 50/152; H01M 50/213; H01M 2220/20

(57) ABSTRACT

Embodiments include an electric vehicle having a battery pack having a plurality of cylindrical battery cells. Each of the plurality of cylindrical battery cells includes an external housing, a jelly roll disposed within the external housing, an extended end cap affixed to one end of the external housing, the extended end cap including a central portion that extends a distance that is at least half of a height of the jelly roll into a central aperture of the jelly roll, and an isolation layer disposed between the jelly roll and the central portion and between the jelly roll and the external housing.

### INTRODUCTION

The disclosure relates to hollow cylindrical battery cells. More specifically, the disclosure relates to hollow cylindrical battery cells and methods and systems for controlling the temperature of hollow cylindrical battery cells in an electric vehicle.

Cylindrical batteries are a common type of battery cell used in electric vehicles. In general, a cylindrical battery is made of a lithium-ion battery with an aluminum or steel casing. The cylindrical shape is created by electrodes and separators layered together and then rolled together in what is referred to as a jelly roll. Cylindrical batteries are easy to manufacture and are convenient to combine into various shapes suitable for the layout of different electric vehicle designs. On average, electric vehicles with cylindrical battery cells have between 5,000 and 9,000 battery cells.

In general, as the batteries in an electric vehicle are charged or discharged, the battery cells heat up and the amount of heat generated depends on how fast the battery is charged or discharged. Overheating of battery cells can affect the performance of the battery cells, which can reduce the range of the electric vehicle. Currently, many electric vehicles utilize a battery pack that has cooling plates that contact the outer surface of the cylindrical battery to cool the battery cells.

Cold temperatures can also negatively impact the performance of lithium-ion batteries. As a result, many electric vehicles include systems for heating batteries. Such systems can include resistive heating systems and heat pumps that are used to heat the outer surfaces of the cylindrical battery cells.

### SUMMARY

In one exemplary embodiment, a cylindrical battery is provided. The cylindrical battery includes an external housing, a jelly roll disposed within the external housing, an extended end cap affixed to one end of the external housing, the extended end cap including a central portion that extends a distance that is at least half of a height of the jelly roll into a central aperture of the jelly roll, and an isolation layer disposed between the jelly roll and the central portion and between the jelly roll and the external housing.

In addition to the one or more features described herein the cylindrical battery further includes a cooling tube disposed within the central portion of the extended end cap.

In addition to the one or more features described herein the cylindrical battery further includes a thermal interface material disposed between the cooling tube and the central portion of the extended end cap.

In addition to the one or more features described herein the cylindrical battery further includes a baffle plate disposed within the cooling tube, wherein the baffle plate divides the cooling tube into two fluidly connected chambers.

In addition to the one or more features described herein the baffle plate includes a plurality of flow guides that are disposed on opposing side of the baffle plate, wherein the plurality of flow guides are configured to control a direction of a flow of a cooling fluid through each of the two fluidly connected chambers.

In one exemplary embodiment, an electric vehicle having a battery pack having a plurality of cylindrical battery cells is provided. Each of the plurality of cylindrical battery cells includes an external housing, a jelly roll disposed within the external housing, an extended end cap affixed to one end of the external housing, the extended end cap including a central portion that extends a distance that is at least half of a height of the jelly roll into a central aperture of the jelly roll, and an isolation layer disposed between the jelly roll and the central portion and between the jelly roll and the external housing.

In addition to the one or more features described herein the each of the plurality of cylindrical battery cells further includes a cooling tube disposed within the central portion of the extended end cap.

In addition to the one or more features described herein the each of the plurality of cylindrical battery cells further includes a thermal interface material disposed between the cooling tube and the central portion of the extended end cap.

In addition to the one or more features described herein the each of the plurality of cylindrical battery cells further includes a baffle plate disposed within the cooling tube, where the baffle plate divides the cooling tube into two fluidly connected chambers.

In addition to the one or more features described herein the electric vehicle also includes a cooling fluid distribution system fluidly connected to the cooling tubes of the plurality of cylindrical battery cells and a pump configured to circulate a cooling fluid through the cooling fluid distribution system and through the cooling tubes of the plurality of cylindrical battery cells.

In addition to the one or more features described herein the electric vehicle also includes sensors configured to monitor a temperature of the plurality of cylindrical battery cells and a controller configured to selectively activate the pump based on the temperature of the plurality of cylindrical battery cells.

In addition to the one or more features described herein the cooling fluid distribution system includes one or more valves that are controlled by the controller, wherein the valves are configured to selectively control a flow of the cooling fluid through the cooling fluid distribution system.

In addition to the one or more features described herein the baffle plate includes a plurality of flow guides that are disposed on opposing side of the baffle plate, wherein the plurality of flow guides are configured to control a direction of the flow of the cooling fluid through each of the two fluidly connected chambers.

In one exemplary embodiment, a method for controlling a temperature of cylindrical battery cells in an electric vehicle is provided. The method includes monitoring the temperature of the cylindrical battery cells and based on a determination that the temperature is greater than a maximum temperature, activating, by a controller, a pump configured to circulate a heat exchange fluid through a fluid distribution system, heat exchange tubes disposed within the cylindrical battery cells, and a first heat exchange device configured to cool the heat exchange fluid. Each of the cylindrical battery cells includes an external housing, a jelly roll disposed within the external housing, and an extended end cap affixed to one end of the external housing, the extended end cap including a central portion that extends a distance that is at least half of a height of the jelly roll into a central aperture of the jelly roll, wherein the heat exchange tube of the cylindrical battery cell is disposed within the central portion of the extended end cap.

In addition to the one or more features described herein the method also includes activating the pump configured to circulate the heat exchange fluid through the fluid distribution system, heat exchange tubes of the cylindrical battery cells, and a second heat exchange device configured to heat the heat exchange fluid based on a determination that the temperature is less than a minimum temperature.

In addition to the one or more features described herein the thermal interface material is disposed between the heat exchange tube and the central portion of the extended end cap of each of the cylindrical battery cells.

In addition to the one or more features described herein the baffle plate is disposed within the heat exchange tube, wherein the baffle plate divides the heat exchange tube into two fluidly connected chambers.

In addition to the one or more features described herein the baffle plate includes a plurality of flow guides that are disposed on opposing side of the baffle plate, wherein the plurality of flow guides are configured to control a direction of a flow of the heat exchange fluid through each of the two fluidly connected chambers.

In addition to the one or more features described herein the fluid distribution system includes one or more valves configured to selectively control a flow of the heat exchange fluid through the heat exchange fluid distribution system.

In addition to the one or more features described herein each of the cylindrical battery cells further includes an isolation layer disposed between the jelly roll and the central portion and between the jelly roll and the external housing.

The above features and advantages, and other features and advantages of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 is a schematic diagram of a vehicle in accordance with an exemplary embodiment;

FIG. 2A is a diagram illustrating a cross-sectional view of a hollow cylindrical battery cell in accordance with an exemplary embodiment;

FIG. 2B is a diagram illustrating a disassembled view of a hollow cylindrical battery cell in accordance with an exemplary embodiment;

FIGS. 3A and 3B are diagrams illustrating cross-sectional views of a hollow cylindrical battery cell in accordance with an exemplary embodiment;

FIG. 3C is a diagram illustrating a perspective view of a portion of a hollow cylindrical battery cell in accordance with an exemplary embodiment;

FIG. 4A is a top view of a portion of a heat exchange fluid distribution system connected to a plurality of hollow cylindrical battery cells in accordance with an exemplary embodiment;

FIG. 4B is a perspective view of a portion of a heat exchange fluid distribution system connected to a plurality of hollow cylindrical battery cells in accordance with an exemplary embodiment;

FIG. 4C is a perspective view of a portion of a cooling fluid distribution system connected to a plurality of hollow cylindrical battery cells in accordance with an exemplary embodiment;

FIG. 5 is a block diagram of a system for controlling the temperature of hollow cylindrical battery cells in an electric vehicle in accordance with an exemplary embodiment; and

FIG. 6 is a flowchart illustrating a method for controlling the temperature of hollow cylindrical battery cells in an electric vehicle in accordance with an exemplary embodiment.

### DETAILED DESCRIPTION

The following description is merely exemplary in nature and is not intended to limit the present disclosure, its application or uses. Various embodiments of the disclosure are described herein with reference to the related drawings. Alternative embodiments of the disclosure can be devised without departing from the scope of the claims. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship.

Turning now to an overview of the aspects of the disclosure, embodiments of the disclosure include an electric vehicle having a battery pack that includes a plurality of hollow cylindrical battery cells. In exemplary embodiments, each hollow cylindrical battery cell includes an external housing and a jelly roll disposed within the external housing. The hollow cylindrical battery cell also includes an extended end cap affixed to one end of the external housing. The extended end cap includes a central portion that extends into a central aperture of the jelly roll. As a result, the hollow cylindrical battery cell can be cooled, or heated, using the surface area of the central portion of the extended end cap in addition to the external housing of the hollow cylindrical battery cell.

In exemplary embodiments, the hollow cylindrical battery cells may be passively cooled or heated by allowing airflow across the external housing and into the central portion of the extended end cap. In other embodiments, the hollow cylindrical battery cells may be actively cooled or heated by passing a heat exchange fluid through a heat exchange tube disposed in the central portion of the extended end cap.

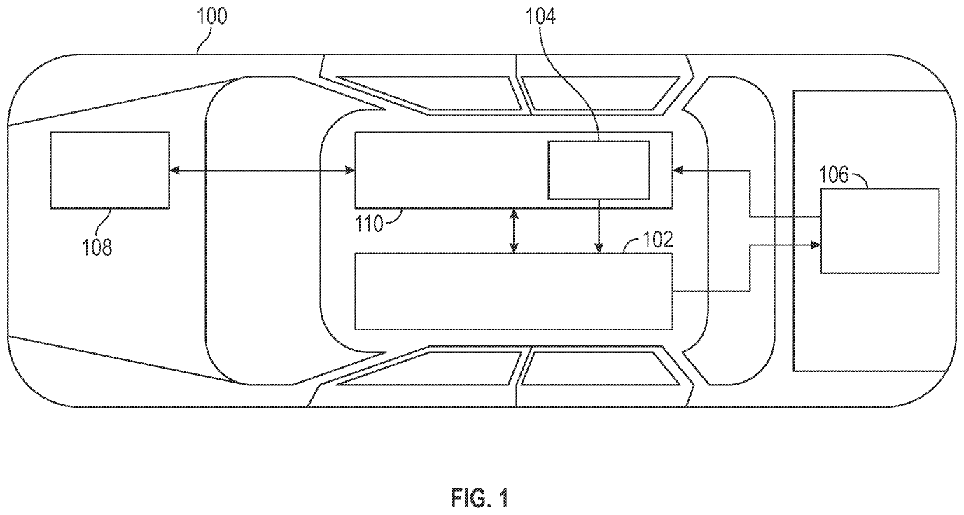

Referring now to FIG. 1, a schematic diagram of an electric vehicle 100 that includes a battery pack 110 according to one or more embodiments is shown. The battery pack 110 includes a plurality of hollow cylindrical battery cells. The electric vehicle 100 also includes a controller 102, temperature sensors 104, a heat exchange system 106, and an electric motor 108. In exemplary embodiments, the controller 102 is one of a general-purpose processor, a Field programmable gate array (FPGA), an application-specific integrated circuit (ASIC), or the like. The temperature sensors 104 are configured to measure the temperature of one or more of the plurality of hollow cylindrical battery cells in the battery pack. The controller 102 is configured to monitor the temperature sensors 104 and to responsively control the heat exchange system 106. The electric motor 108 is configured to provide propulsion to the electric vehicle 100 by drawing power from the battery pack 110.

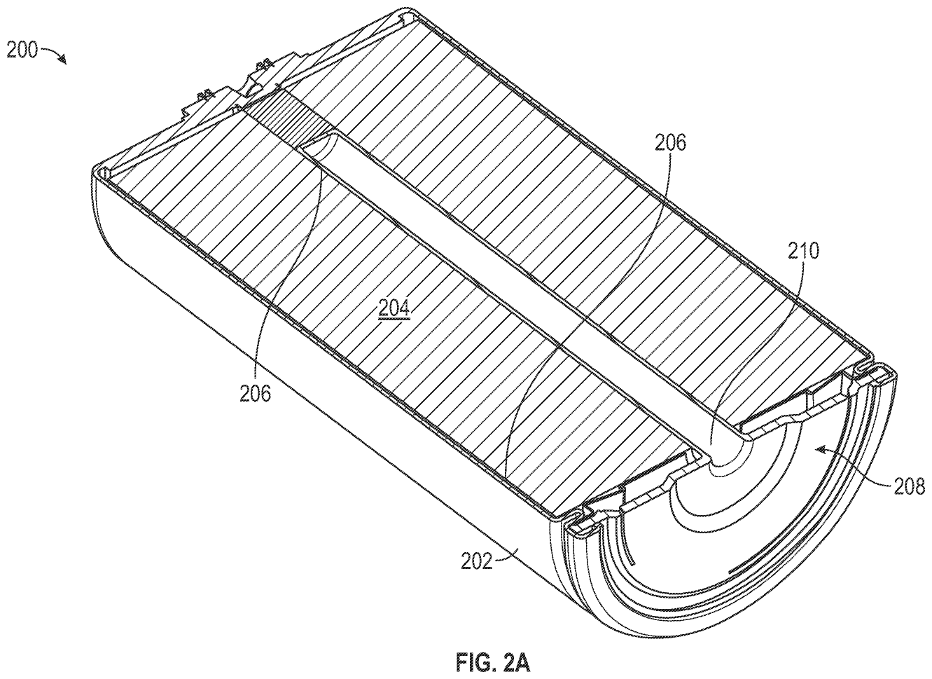

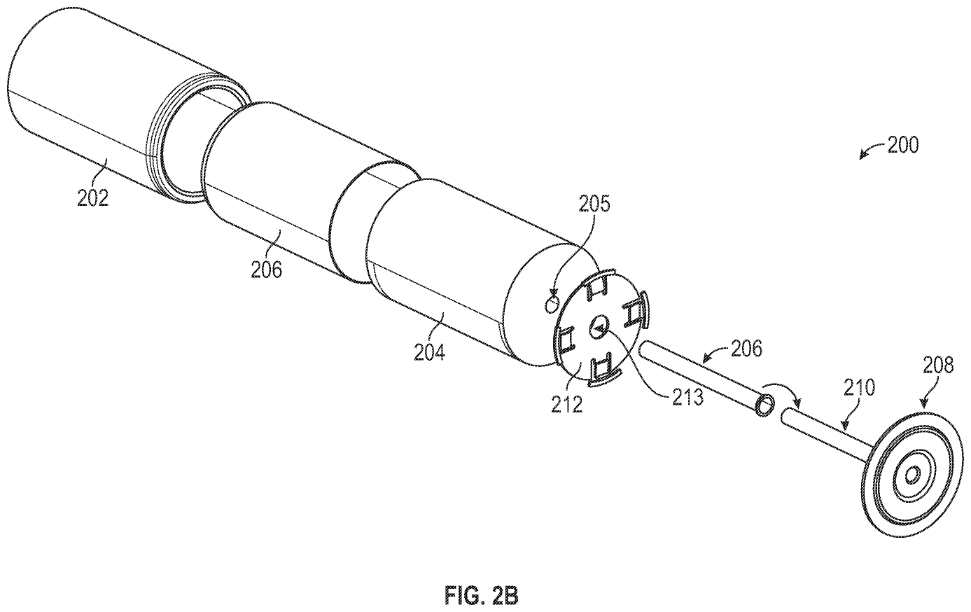

Referring now to FIGS. 2A and 2B, cross-sectional and disassembled views of a hollow cylindrical battery cell 200 in accordance with an exemplary embodiment are respectively shown. As illustrated, the hollow cylindrical battery cell 200 includes an external housing 202, which may be constructed of steel, aluminum, or another suitable material. The hollow cylindrical battery cell 200 also includes a jelly roll 204. The jelly roll 204 is an annular structure that is created by rolling different layers of a lithium-ion battery into a cylindrical roll. The jelly roll 204 includes a central aperture 205 that extends the entire length of the jelly roll 204.

The hollow cylindrical battery cell 200 also includes an extended end cap 208 that is affixed to one end of the external housing 202. The extended end cap 208 includes a central portion 210 that extends into the central aperture 205 of the jelly roll 204. In exemplary embodiments, the central portion 210 extends into the central aperture 205 at least halfway through the jelly roll 204. In exemplary embodiments, the hollow cylindrical battery cell 200 also includes isolation layers 206 that are disposed between the jelly roll 204 and the central portion 210 of the extended end cap 208 and between the jelly roll 204 and the external housing 202. The isolation layer 206 is configured to electrically isolate the adjacent materials from each other, (i.e., to electrically isolate the jelly roll 204 and the external housing 202). In exemplary embodiments, the hollow cylindrical battery cell 200 also includes a collector plate 212 that is disposed between the jelly roll 204 and the extended end cap 208. The collector plate 212 includes a central aperture 213 through which the central portion 210 of the extended end cap 208 passes.

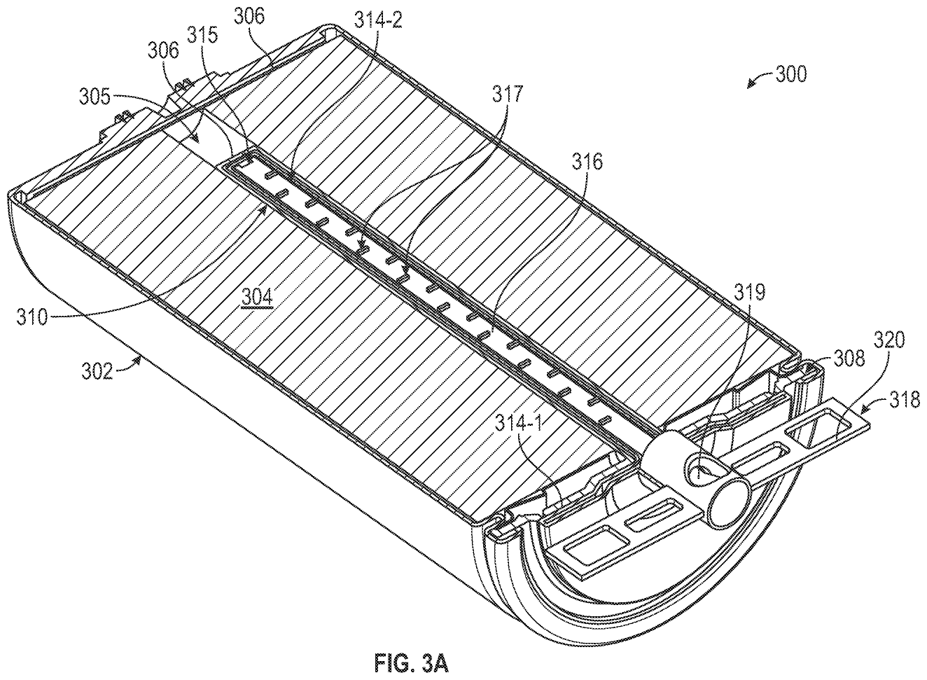

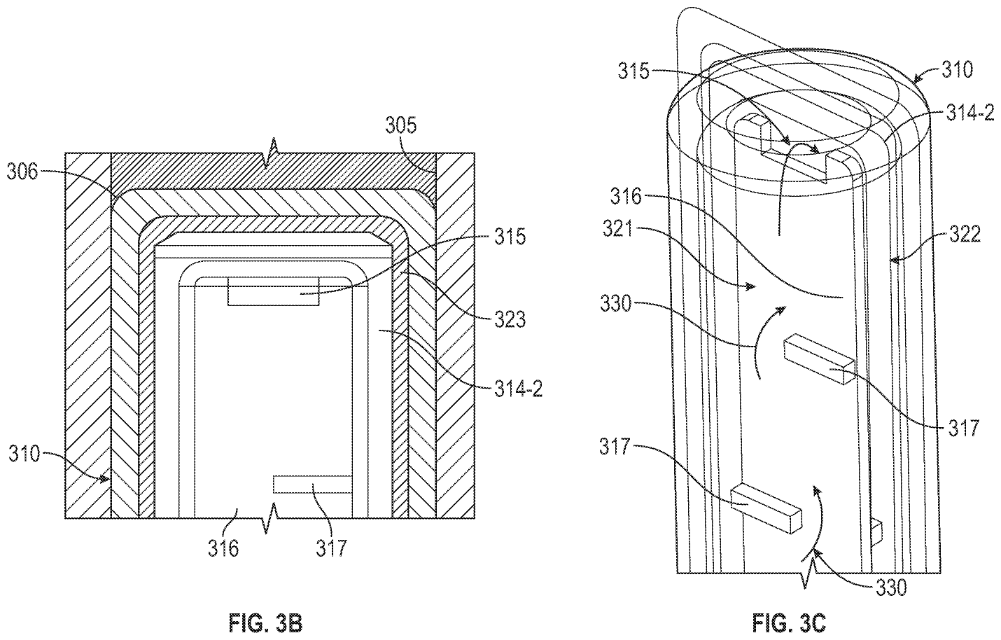

Referring now to FIGS. 3A, 3B, and 3C, cross-sectional and perspective views of a hollow cylindrical battery cell 300 in accordance with an exemplary embodiment are shown. As illustrated, the hollow cylindrical battery cell 300 includes an outer casing 302, which may be constructed of steel, aluminum, or another suitable material. The hollow cylindrical battery cell 300 also includes a jelly roll 304. The jelly roll 304 is an annular structure that is created by rolling different layers of a lithium-ion battery into a cylindrical roll. The jelly roll 304 includes a central aperture 305 that extends the entire length of the jelly roll 304.

The hollow cylindrical battery cell 300 also includes an extended end cap 308 that is affixed to one end of the outer casing 302. The extended end cap 308 includes a central portion 310 that extends into the central aperture 305 of the jelly roll 304. In exemplary embodiments, the hollow cylindrical battery cell 300 also includes isolation layers 306 that are disposed between the jelly roll 304 and the central portion 310 of the extended end cap 308 and between the jelly roll 304 and the external housing 202.

In exemplary embodiments, the hollow cylindrical battery cell 300 also includes a cooling tube 314, also referred to herein as a heat exchange tube 314. The cooling tube 314 includes a first portion 314-1 that is disposed on the opposite side of the extended end cap 308 from the jelly roll 304 and a second portion 314-2 that is disposed within the central aperture 305 of the jelly roll 304. In exemplary embodiments, the cooling tube 314 is constructed of steel, aluminum, or another suitable material that is configured to dissipate heat generated by the jelly roll 304.

In exemplary embodiments, the hollow cylindrical battery cell 300 also includes a baffle plate 316 that is disposed within the second portion 314-2 of the cooling tube 314. In exemplary embodiments, the baffle plate 316 separates the second portion 314-2 of the cooling tube 314 into two fluidly connected chambers 321, 322. In one embodiment, the baffle plate 316 includes an aperture 315 disposed on a distal end of the baffle plate 316 that fluidly connects chamber 321 to chamber 322. In one embodiment, one or both sides of the baffle plate 316 include a plurality of flow guides 317 that are configured to control the direction of a flow 330 of a heat exchange fluid through each of the two fluidly connected chambers 321, 322, as best shown in FIG. 3C.

In exemplary embodiments, the hollow cylindrical battery cell 300 also includes a fluid connector 318 that is affixed to the proximal end of the baffle plate 316. The fluid connector 318 includes fluid inlets/outlets 319 that are configured to permit the flow of a heat exchange fluid through the chambers 321, 322. In exemplary embodiments, the fluid connector 318 also includes stabilizers 320 that extend from a central portion of the fluid connector. In exemplary embodiments, fluid connector 318 is configured to connect the hollow cylindrical battery cells 300 to a heat exchange fluid distribution system.

In exemplary embodiments, the hollow cylindrical battery cell 300 also includes a thermal interface material 323 that is disposed between the cooling tube 314 and the central portion 310 of the extended end cap 308. The thermal interface material 323 is configured to conduct heat between cooling tube 314 and the central portion 310 of the extended end cap 308.

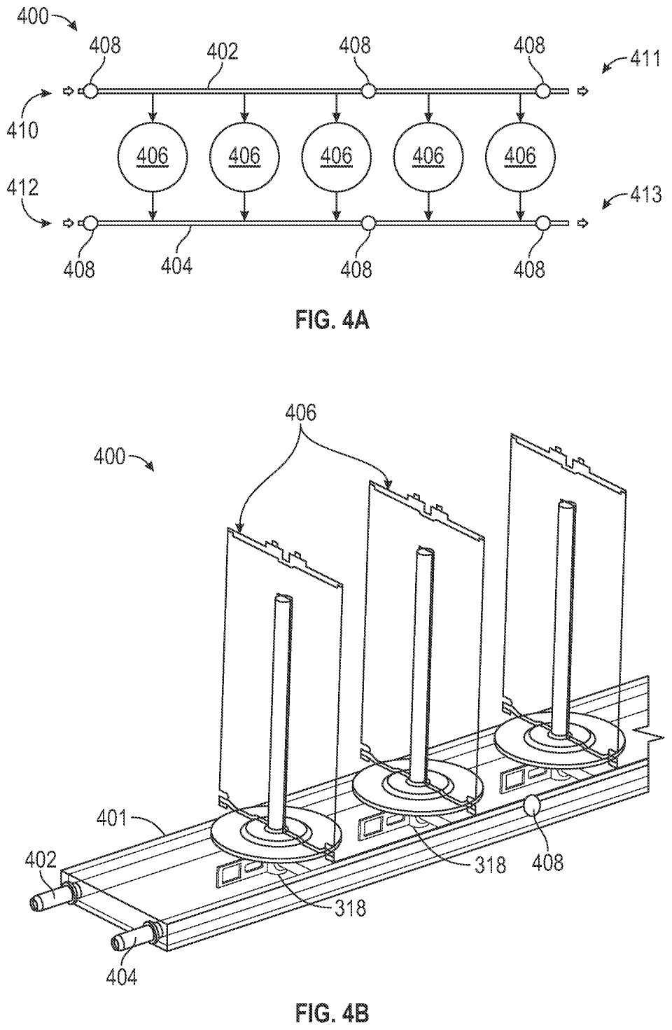

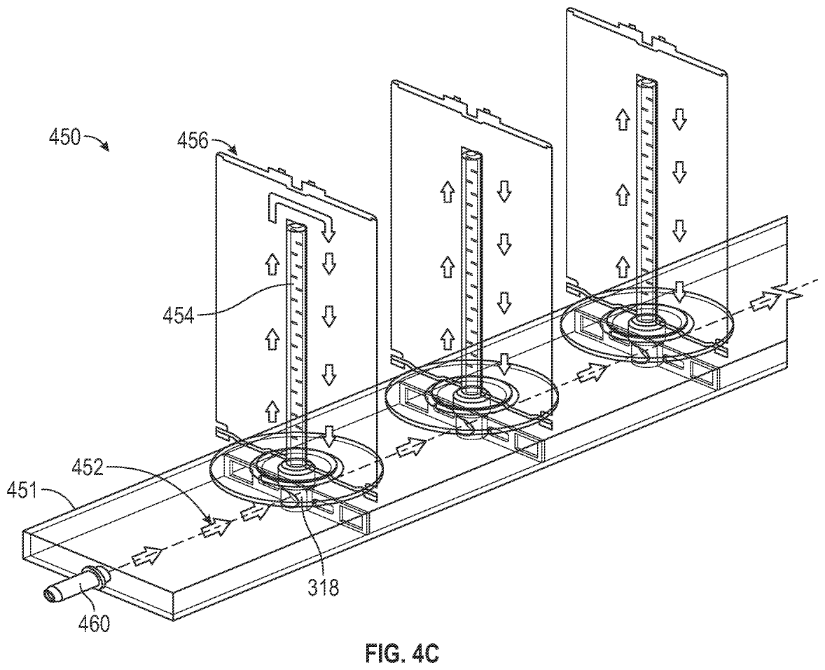

Referring now to FIGS. 4A and 4B, a top view and a perspective view of a portion of a heat exchange fluid distribution system 400 connected to a plurality of hollow cylindrical battery cells 406 in accordance with an exemplary embodiment are respectively shown. A cross-section of the hollow cylindrical battery cells 406 are shown in FIG. 4B. As illustrated, the heat exchange fluid distribution system 400 includes fluid inlets 410, 412, fluid outlets 411, 413, and tubing 402, 404. In one embodiment, the tubing 402, 404 is disposed in housing 401 and the tubing 402, 404 is affixed to a fluid connector 318 of the hollow cylindrical battery cells 406, which is also disposed in the housing 401.

The heat exchange fluid distribution system 400 also includes one or more valves 408 that are configured to control the flow of a heat exchange fluid through the tubing 402, 404, and the hollow cylindrical battery cells 406. In exemplary embodiments, the valves 408 of the heat exchange fluid distribution system 400 are controlled by a controller (not shown), which controls the flow of a heat exchange fluid through the tubing 402, 404, and the hollow cylindrical battery cells 406. As used herein, the term heat exchange fluid refers to a fluid that can be used to heat the hollow cylindrical battery cells 406 (i.e., a heating fluid) or to cool the hollow cylindrical battery cells 406 (i.e., a cooling fluid).

In one embodiment, where the temperature of hollow cylindrical battery cells 406 is above a threshold maximum temperature, the controller is configured to open a valve 408 adjacent to fluid inlet 410 and open a valve 408 adjacent to fluid outlet 413, thereby allowing a cooling fluid to flow through the hollow cylindrical battery cells 406. In another embodiment, where the temperature of hollow cylindrical battery cells 406 is below a threshold minimum temperature, the controller is configured to open a valve 408 adjacent to fluid inlet 412 and open a valve 408 adjacent to fluid outlet 411, thereby allowing a heating fluid to flow through the hollow cylindrical battery cells 406.

Referring now to FIG. 4C, a perspective view of a portion of a cooling fluid distribution system 450 connected to a plurality of hollow cylindrical battery cells 456 (a cross section of which is shown) in accordance with an exemplary embodiment is shown. As illustrated, the heat exchange fluid distribution system 450 includes a fluid inlet 460, a fluid outlet (not shown), and tubing 452. In exemplary embodiments, the tubing 452 is disposed in a housing 451 of the cooling fluid distribution system 450. In addition, tubing 452 is affixed to a fluid connector 318 of the hollow cylindrical battery cells 456, which are also disposed in the housing 451. As shown, a cooling fluid enters the cooling fluid distribution system 450 via inlet 460, travels through tubing 452 into the hollow cylindrical battery cells 456, and flows up and over the baffle plate 454, thereby dissipating heat generated by the hollow cylindrical battery cells 456.

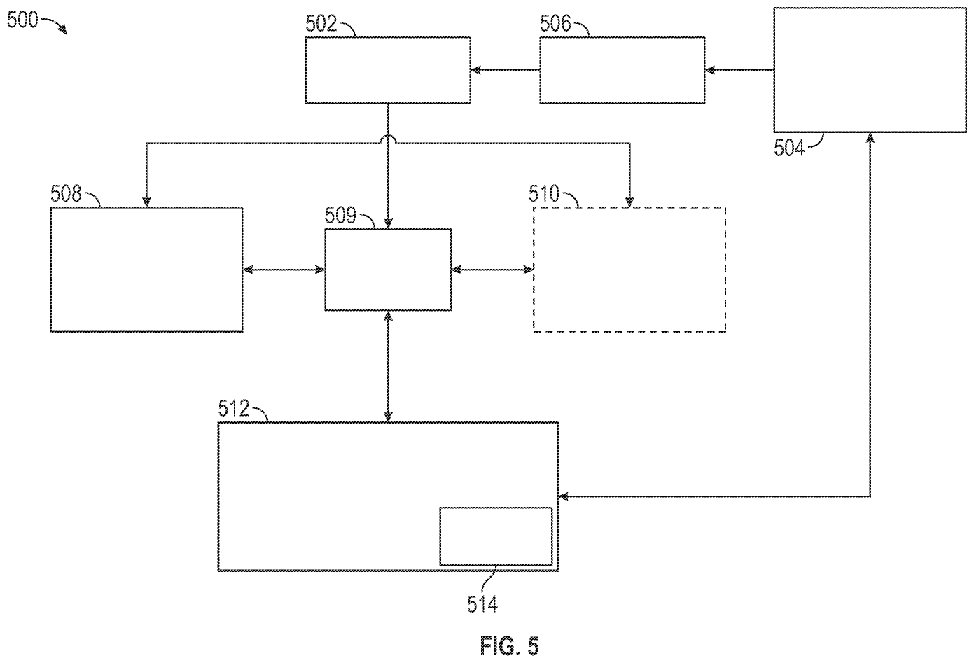

Referring now to FIG. 5 a block diagram of a system 500 for controlling the temperature of hollow cylindrical battery cells in an electric vehicle in accordance with an exemplary embodiment is shown. As illustrated, the system 500 includes a controller 502, hollow cylindrical battery cells 504 (hollow cylindrical battery cell 300 shown in FIGS. 3A, 3B, and 3C), and one or more temperature sensors 506. In exemplary embodiments, the controller 502 is one of a general-purpose processor, a Field programmable gate array (FPGA), an application-specific integrated circuit (ASIC), or the like. The sensors 506 are configured to measure the temperature of one or more of the plurality of hollow cylindrical battery cells 504.

The system 500 also includes a first heat exchange device 508, a pump, and optionally a second heat exchange device 510, which are each controlled by the controller 502. In one embodiment, the first heat exchange device 508 is configured to remove heat from a heat exchange fluid, or cooling fluid. For example, the first heat exchange device 508 may be a radiator. In one embodiment, the second heat exchange device 510 is configured to heat a heat exchange fluid, or heating fluid. For example, the second heat exchange device 510 may be a restive heating element.

In exemplary embodiments, the system 500 includes one or more pumps 509 that are configured to selectively pump a heat exchange fluid through the first heat exchange device 508 and a heat exchange fluid distribution system 512 to cool the hollow cylindrical battery cells 504. Likewise, one or more of the pumps 509 are configured to selectively pump a heat exchange fluid through the second heat exchange device 510 and a heat exchange fluid distribution system 512 to heat the hollow cylindrical battery cells 504. In exemplary embodiments, the controller 502 is configured to selectively activate the pump 509, the first heat exchange device 508, the second heat exchange device 510, and one or more valves 514 of the heat exchange fluid distribution system 512 based on the temperature of the hollow cylindrical battery cells 504.

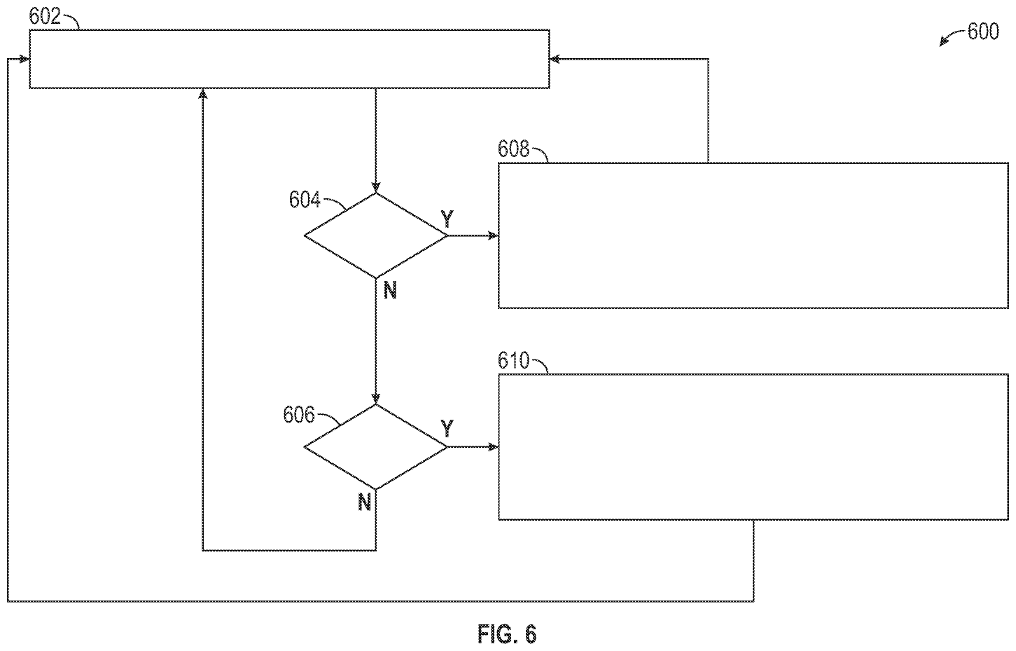

Referring now to FIG. 6, a flowchart illustrating a method 600 for controlling the temperature of hollow cylindrical battery cells in an electric vehicle in accordance with an exemplary embodiment is shown. At block 602, the method includes obtaining the temperature of one or more cylindrical battery cells in a battery pack of the electric vehicle. Next, at decision block 604, the method 600 includes determining whether the temperature of one or more cylindrical battery cells in the battery pack is above a maximum temperature value.

Based on a determination that the temperature of one or more cylindrical battery cells in the battery pack is above the maximum temperature value, the method 600 proceeds to block 608. At block 608, the method 600 includes circulating a heat exchange fluid through a fluid distribution system, heat exchange tubes disposed within the cylindrical battery cells, and a first heat exchange device configured to cool the heat exchange fluid.

At decision block 606, the method 600 includes determining whether the temperature of one or more cylindrical battery cells in the battery pack is below a minimum temperature value. Based on a determination that the temperature of one or more cylindrical battery cells in the battery pack is below the minimum temperature value, the method 600 proceeds to block 610. At block 610, the method 600 includes circulating a heat exchange fluid through a fluid distribution system, heat exchange tubes disposed within the cylindrical battery cells, and a second heat exchange device configured to heat the heat exchange fluid.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A cylindrical battery comprising:
an external housing;
a jelly roll disposed within the external housing;
an extended end cap affixed to one end of the external housing, the extended end cap including a central portion that extends a distance that is at least half of a height of the jelly roll into a central aperture of the jelly roll; and
an isolation layer disposed between the jelly roll and the central portion and between the jelly roll and the external housing.

2. The cylindrical battery of claim 1, further comprising a cooling tube disposed within the central portion of the extended end cap.

3. The cylindrical battery of claim 2, further comprising a thermal interface material disposed between the cooling tube and the central portion of the extended end cap.

4. The cylindrical battery of claim 3, further comprising a baffle plate disposed within the cooling tube, wherein the baffle plate divides the cooling tube into two fluidly connected chambers.

5. The cylindrical battery of claim 4, wherein the baffle plate includes a plurality of flow guides that are disposed on opposing side of the baffle plate, wherein the plurality of flow guides are configured to control a direction of a flow of a cooling fluid through each of the two fluidly connected chambers.

6. An electric vehicle comprising:
a battery pack having a plurality of cylindrical battery cells, each of the plurality of cylindrical battery cells comprising:
an external housing;
a jelly roll disposed within the external housing;
an extended end cap affixed to one end of the external housing, the extended end cap including a central portion that extends a distance that is at least half of a height of the jelly roll into a central aperture of the jelly roll; and
an isolation layer disposed between the jelly roll and the central portion and between the jelly roll and the external housing.

7. The electric vehicle of claim 6, wherein the each of the plurality of cylindrical battery cells further comprises a cooling tube disposed within the central portion of the extended end cap.

8. The electric vehicle of claim 7, wherein the each of the plurality of cylindrical battery cells further comprises a thermal interface material disposed between the cooling tube and the central portion of the extended end cap.

9. The electric vehicle of claim 8, wherein the each of the plurality of cylindrical battery cells further comprises a baffle plate disposed within the cooling tube, wherein the baffle plate divides the cooling tube into two fluidly connected chambers.

10. The electric vehicle of claim 9, further comprising:
a cooling fluid distribution system fluidly connected to the cooling tubes of the plurality of cylindrical battery cells; and
a pump configured to circulate a cooling fluid through the cooling fluid distribution system and through the cooling tubes of the plurality of cylindrical battery cells.

11. The electric vehicle of claim 10, further comprising:
sensors configured to monitor a temperature of the plurality of cylindrical battery cells; and
a controller configured to selectively activate the pump based on the temperature of the plurality of cylindrical battery cells.

12. The electric vehicle of claim 11, wherein the cooling fluid distribution system includes one or more valves that are controlled by the controller, wherein the valves are configured to selectively control a flow of the cooling fluid through the cooling fluid distribution system.

13. The electric vehicle of claim 10, wherein the baffle plate includes a plurality of flow guides that are disposed on opposing side of the baffle plate, wherein the plurality of flow guides are configured to control a direction of the flow of the cooling fluid through each of the two fluidly connected chambers.

14. A method for controlling a temperature of cylindrical battery cells in an electric vehicle, the method comprising:
monitoring the temperature of the cylindrical battery cells;
based on a determination that the temperature is greater than a maximum temperature, activating, by a controller, a pump configured to circulate a heat exchange fluid through a fluid distribution system, heat exchange tubes disposed within the cylindrical battery cells, and a first heat exchange device configured to cool the heat exchange fluid,
wherein each of the cylindrical battery cells includes:
an external housing;
a jelly roll disposed within the external housing; and
an extended end cap affixed to one end of the external housing, the extended end cap including a central portion that extends a distance that is at least half of a height of the jelly roll into a central aperture of the jelly roll, wherein the heat exchange tube of the cylindrical battery cell is disposed within the central portion of the extended end cap.

15. The method of claim 14, further comprising:
based on a determination that the temperature is less than a minimum temperature, activating the pump configured to circulate the heat exchange fluid through the fluid distribution system, heat exchange tubes of the cylindrical battery cells, and a second heat exchange device configured to heat the heat exchange fluid.

16. The method of claim 14, wherein a thermal interface material is disposed between the heat exchange tube and the central portion of the extended end cap of each of the cylindrical battery cells.

17. The method of claim 14, wherein a baffle plate is disposed within the heat exchange tubes, wherein the baffle plate divides the heat exchange tubes into two fluidly connected chambers.

18. The method of claim 17, wherein the baffle plate includes a plurality of flow guides that are disposed on opposing side of the baffle plate, wherein the plurality of flow guides are configured to control a direction of a flow of the heat exchange fluid through each of the two fluidly connected chambers.

19. The method of claim 14, wherein the fluid distribution system includes one or more valves configured to selectively control a flow of the heat exchange fluid through the heat exchange fluid distribution system.

20. The method of claim 14, wherein each of the cylindrical battery cells further includes an isolation layer disposed between the jelly roll and the central portion and between the jelly roll and the external housing.
